(19) United States
(12) Patent Application Publication
(10) Pub. No.: US 2015/0322197 A1
(43) Pub. Date: Nov. 12, 2015

(54) LATENT CATALYTIC CURING AGENT

(71) Applicant: Dow Global Technologies LLC, Midland, MI (US)

(72) Inventor: Maurice J. Marks, Lake Jackson, TX (US)

(21) Appl. No.: 14/391,732

(22) PCT Filed: May 17, 2013
(86) PCT No.: PCT/US2013/041557

§ 371 Date: Oct. 10, 2014

Related U.S. Application Data
(60) Provisional application No. 61/660,403, filed on Jun. 15, 2012.

(51) Int. Cl. C08G 59/42; C08G 59/40; C08L 63/00

(52) U.S. Cl. CPC C08G 59/4207; C08L 63/00; C08G 59/4071; C08G 59/4064

(57) ABSTRACT

A curable composition including (a) at least one divinylarene dioxide and (b) at least one latent catalytic curing agent; a process for preparing the curable composition; and a cured composition prepared from the curable composition.

### FIELD

The present invention is related to catalytic curing agents for divinylarene dioxides, particularly, catalytic curing agents having latent curing activity; and compositions utilizing said latent catalytic curing agents.

### BACKGROUND

It is known in the art to prepare a curable composition containing a combination of (i) a divinylarene dioxide, and (ii) a catalytic curing agent such as mineral acids, sulfonic acids, Lewis acids, alkali bases, and tertiary amines as disclosed in U.S. Pat. No. 2,924,580 (herein “the '580 patent”). The catalytic curing agents disclosed in the '580 patent are not latent because such agents initiate cure at ambient temperatures and quickly cause increased formulation viscosity. For instance, Examples 5-14 of the '580 patent show that benzyldimethylamine is used in concentrations high enough to cure divinylbenzene dioxide into a hard solid, but also causes the composition to gel within 70 hours at 26° C. at the high concentrations.

### SUMMARY

One embodiment of the present invention is directed to a curable composition including (a) at least one divinylarene dioxide and (b) at least one latent catalytic curing agent.

Another embodiment of the present invention is directed to a process for preparing a curable composition including admixing (a) at least one divinylarene dioxide; and (b) at least one latent catalytic curing agent.

Still another embodiment of the present invention is directed to a cured thermoset product prepared from the above curable composition by curing the above curable composition.

The present invention provides a latent catalytic curing agent for curing a divinylarene dioxide. For example, the latent catalytic curing agent useful in the present invention may include at least one alkylating ester latent catalytic curing agent. The alkylating ester latent catalytic curing agent is effective in catalyzing the polymerization reaction of the divinylarene dioxide.

In addition, the alkylating ester latent catalytic curing agent provides latency of cure to the curable composition. “Latency of cure” herein means curing that begins at a temperature higher than about 25° C. Latency of cure of a curable composition can also be based on how much the viscosity of a curable composition increases from its initial viscosity over a period of time.

For example, the curable composition of the present invention can have a viscosity increase factor (VIF) of less than about 4. “Viscosity Increase Factor (VIF)” herein means the ratio of viscosity of a formulation upon standing at about 25° C. for 7 days and the initial viscosity of the formulation. And, because the curable composition of the present invention can have a VIF of less than about 4, the latent catalytic curing agent of the present invention advantageously provides curable compositions or formulations with improved storage stability properties and good curing activity at elevated temperatures.

### DETAILED DESCRIPTION

In its broadest scope, the present invention includes a curable composition comprising a mixture of (a) at least one divinylarene dioxide; and (b) at least one latent catalytic curing agent, wherein said latent catalytic curing agent being effective in catalyzing the curing of the divinylarene dioxide at elevated temperatures; and wherein said latent catalytic curing agent being effective in providing latency of cure to the curable composition. The curable composition of the present invention can be cured to form a cured composite or thermoset by exposing the curable composition to elevated temperatures.

The divinylarene dioxide useful in the present invention can be any of the divinylarene dioxides described in U.S. patent application Ser. No. 13/133,510. In one embodiment, the divinylarene dioxide, component (a), useful in preparing the curable composition of the present invention may comprise, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, orpara isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthalene, and tetrahydronaphthalene. Homologously bonded (substituted) benzenes may consist of biphenyl, and diphenylether.

The divinylarene dioxide used for preparing the formulations of the present invention may be illustrated generally by general chemical Structures I-IV as follows:

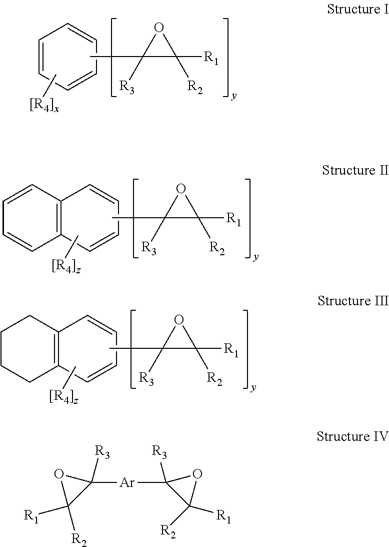

In the above Structures I, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide used in the present invention may be produced, for example, by the process described in U.S. Patent Provisional Application Ser. No. 61/141,457. The divinylarene dioxide compositions that are useful in the present invention are also disclosed in, for example, U.S. Pat. No. 2,924,580.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In one preferred embodiment of the present invention, the divinylarene dioxide used in the epoxy resin formulation may be for example divinylbenzene dioxide (DVBDO). In another preferred embodiment, the divinylarene dioxide component that is useful in the present invention includes, for example, a divinylbenzene dioxide as illustrated by the following chemical formula of Structure V:

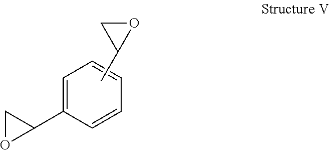

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and O, 19.73 with an epoxide equivalent weight of about 81 g/mol.

Divinylarene dioxides, particularly those derived from divinylbenzene such as for example DVBDO, are class of diepoxides which have a relatively low liquid viscosity but a higher rigidity and crosslink density than conventional epoxy resins.

Structure VI below illustrates an embodiment of a preferred chemical structure of the DVBDO useful in the present invention:

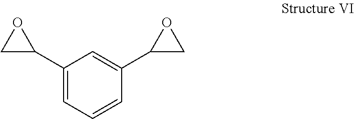 [SMILES: c1cc(C2CO2)cc(C2CO2)c1]

Structure VII below illustrates another embodiment of a preferred chemical structure of the DVBDO useful in the present invention:

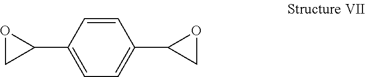 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from 9:1 to 1:9 ratio of meta (Structure VI) to para (Structure VII) isomers. The present invention preferably includes as one embodiment a range of from 6:1 to 1:6 ratio of Structure VI to Structure VII, and in other embodiments the ratio of Structure VI to Structure VII may be from 4:1 to 1:4 or from 2:1 to 1:2.

In yet another embodiment of the present invention, the divinylarene dioxide may contain quantities (such as for example less than 20 wt %) of substituted arenes and/or arene oxides. The amount and structure of the substituted arenes and/or arene oxides depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene oxide while DEB remains unchanged. The presence of these compounds can increase the epoxide equivalent weight of the divinylarene dioxide to a value greater than that of the pure compound but can be utilized at levels of 0 to 99% of the epoxy resin portion.

In one embodiment, the divinylarene dioxide, for example DVBDO, useful in the present invention comprises a low viscosity liquid epoxy resin. For example, the viscosity of the divinylarene dioxide used in the present invention ranges generally from 0.001 Pa s to 0.1 Pa s in one embodiment, from 0.01 Pa s to 0.05 Pa s in another embodiment, and from 0.01 Pa s to 0.025 Pa s in still another embodiment, at 25° C.

The concentration of the divinylarene oxide used in the present invention composition may range generally from 0.5 weight percent (wt %) to 100 wt % in one embodiment, from 1 wt % to 99 wt % in another embodiment, from 2 wt % to 98 wt % in still another embodiment, and from 5 wt % to 95 wt % in yet another embodiment, depending on the fractions of the other ingredients in the reaction product composition.

One advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from 6 to 10 rotational degrees of freedom in one embodiment, from 6 to 9 rotational degrees of freedom in another embodiment, and from 6 to 8 rotational degrees of freedom in still another embodiment.

The latent catalytic curing agents useful in the present invention may include for example alkylating esters of sulfonic, phosphonic, halocarboxylic acids, and mixtures thereof.

In preparing the curable resin formulation of the present invention, the latent alkylating ester catalytic curing agent is used to facilitate the curing reaction of the divinylarene dioxide at elevated temperatures. The latent alkylating ester catalytic curing agent useful in the present invention may include, for example, any of the catalysts described in WO 9518168.

In one embodiment, the latent alkylating ester catalytic curing agent may include for example the esters of sulfonic acids such as methyl p-toluenesulfonate, ethyl p-toluenesulfonate, and methyl methanesulfonate; esters of α-halogenated carboxylic acids such as methyl trichloroacetate and methyl trifluoroacetate; and esters of phosphonic acids such as tetraethylmethylenediphosphonate; or any combination thereof.

Most preferred embodiments of the latent alkylating ester catalytic curing agent may include methyl p-toluenesulfonate, ethyl p-toluenesulfonate, methyl methanesulfonate, methyl trichloroacetate, methyl trifluoroacetate, tetraethylmethylenediphosphonate, or mixtures thereof.

The concentration of the latent alkylating ester catalytic curing agent used in the present invention may range generally from 0.01 wt % to 20 wt % in one embodiment, from 0.1 wt % to 10 wt % in another embodiment, from 1 wt % to 10 wt % in still another embodiment, and from 2 wt % to 10 wt % in yet another embodiment.

Optional compounds that may be added to the curable composition of the present invention may include, for example, other epoxy resins different from the divinylarene dioxide (e.g., aromatic and aliphatic glycidyl ethers, cycloaliphatic epoxy resins). For example, the epoxy resin which is different from the divinylarene dioxide may be any epoxy resin component or combination of two or more epoxy resins known in the art such as epoxy resins described in Lee, H. and Neville, K., Handbook of Epoxy Resins, McGraw-Hill Book Company, New York, 1967, Chapter 2, pages 2-1 to 2-27.

Suitable other epoxy resins known in the art include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy resin may also be selected from commercially available products such as for example, D.E.R. 331®, D.E.R. 332, D.E.R. 354, D.E.R. 580, D.E.N. 425, D.E.N. 431, D.E.N. 438, D.E.R. 736, or D.E.R. 732 epoxy resins available from The Dow Chemical Company.

Generally, the amount of the other epoxy resin, when used in the present invention, may be for example, from 0 equivalent % to 99 equivalent % in one embodiment, from 0.1 equivalent % to 95 equivalent % in another embodiment; from 1 equivalent % to 90 equivalent % in still another embodiment; and from 5 equivalent % to 80 equivalent % of the total epoxides in yet another embodiment.

Another optional compound useful for the curable composition of the present invention may comprise any conventional curing agent known in the art. The curing agent, (also referred to as a hardener or cross-linking agent) useful in the curable composition, may be selected, for example, from those curing agents well known in the art including, but are not limited to, anhydrides, carboxylic acids, amine compounds, phenolic compounds, polymercaptans, or mixtures thereof.

Examples of optional curing agents useful in the present invention may include any of the co-reactive or catalytic curing materials known to be useful for curing epoxy resin based compositions. Such co-reactive curing agents include, for example, polyamine, polyamide, polyaminoamide, dicyandiamide, polymeric thiol, polycarboxylic acid and anhydride, and any combination thereof or the like. Suitable catalytic curing agents include tertiary amine, quaternary ammonium halide, Lewis acids such as boron trifluoride, and any combination thereof or the like. Other specific examples of co-reactive curing agent include diaminodiphenylsulfone, styrene-maleic acid anhydride (SMA) copolymers; and any combination thereof. Among the conventional co-reactive epoxy curing agents, amines and amino or amido containing resins and phenolics are preferred. Still another class of optional curing agents useful in the compositions of the present invention include anhydrides and mixtures of anhydrides with other curing agents.

Generally, the amount of optional curing agent, when used in the present invention, may be for example, from 0 equivalent % to 99 equivalent % in one embodiment, from 0.1 equivalent % to 90 equivalent % in another embodiment; from 1 equivalent % to 75 equivalent % in still another embodiment; and from 5 equivalent % to 50 equivalent % in yet another embodiment, based on the total curing agent functional groups.

Other optional components that may be useful in the present invention are components normally used in resin formulations known to those skilled in the art. For example, the optional components may comprise compounds that can be added to the composition to enhance application properties (e.g. surface tension modifiers or flow aids), reliability properties (e.g. adhesion promoters), and/or the catalyst lifetime.

An assortment of other additives may be added to the compositions or formulations of the present invention including for example, other curing agents, fillers, pigments, toughening agents, flow modifiers, other resins different from the epoxy resins and the divinylarene dioxide, diluents, stabilizers, fillers, plasticizers, catalyst de-activators, a halogen containing or halogen free flame retardant; a solvent for processability including for example acetone, methyl ethyl ketone, an Dowanol PMA; adhesion promoters such as modified organosilanes (epoxidized, methacryl, amino), acytlacetonates, or sulfur containing molecules; wetting and dispersing aids such as modified organosilanes; a reactive or non-reactive thermoplastic resin such as polyphenylsulfones, polysulfones, polyethersolufones, polyvinylidene fluoride, polyetherimide, polypthalimide, polybenzimidiazole, acrylics, phenoxy, urethane; a mold release agent such as waxes; other functional additives or pre-reacted products to improve polymer properties such as isocyanates, isocyanurates, cyanate esters, allyl containing molecules or other ethylenically unsaturated compounds, and acrylates; or mixtures thereof.

The concentration of the optional additives useful in the present invention may range generally from 0 wt % to 90 wt % in one embodiment, from 0.01 wt % to 80 wt % in another embodiment, from 0.1 wt % to 65 wt % in still another embodiment, and from 0.5 wt % to 50 wt % in yet another embodiment.

In one embodiment, the process for preparing the curable composition of the present invention includes combining, blending or mixing (a) at least one divinylarene dioxide; and (b) at least one latent catalytic curing agent; and (c) optionally, other ingredients as needed. For example, the preparation of the curable epoxy resin formulation of the present invention is achieved by blending with or without vacuum in a Ross PD Mixer (Charles Ross), a divinylarene dioxide, a latent catalytic curing agent, and optionally any other desirable additives. Any of the above-mentioned optional assorted formulation additives, for example an additional epoxy resin, may also be added to the curable composition during the mixing or prior to the mixing of the compounds to form the curable composition.

All the components of the epoxy resin formulation are typically mixed and dispersed at a temperature enabling the preparation of an effective epoxy resin composition having the desired balance of properties for a particular application. For example, the temperature during the mixing of all components may be generally from −10° C. to 100° C. in one embodiment, and from 0° C. to 50° C. in another embodiment. Lower mixing temperatures help to minimize reaction of the divinylarene dioxide; and latent catalytic curing agent components to maximize the pot life of the formulation.

The blended compound is typically stored at sub-ambient temperatures to maximize shelf life. Acceptable temperature ranges are for example from −100° C. to 25° C. in one embodiment, from −70° C. to 10° C. in another embodiment, and from −50° C. to 0° C. in still another embodiment. As an illustration of one embodiment, the temperature at which the blended formulation is stored may be 0° C.

The blended formulation can then be used in a number of enduse applications and can be formed into an article via several methods such as for example, application methods including casting, injection molding, extrusion, rolling, and spraying.

Compared to curable compositions of the prior art, the curable compositions of the present invention have sufficient latency of curing to provide a composition with a longer shelf life by virtue of the use of the latent catalytic curing agent such as a latent alkylating ester.

The latency of cure of the curable composition can be described with reference to the viscosity increase factor (VIF) of the curable composition wherein the VIF is generally less than 4 in one embodiment, from 1.0 to 4 in another embodiment, from 1.0 to 3.5 in yet another embodiment, from 1.0 to 3.0 in yet another embodiment, from 1.0 to 2.5 in yet another embodiment, from 1.0 to 2.0 in yet another embodiment, and from 1.0 to 1.5 in yet another embodiment.

The viscosity increase factor (VIF) can be determined by measuring the viscosity of the initial curable formulation at 25° C. and then measuring the viscosity of the curable formulation at 25° C. after standing at 25° C. for 7 days. The VIF is a ratio of the final viscosity of a formulation upon standing at 25° C. for 7 days to the initial viscosity of the formulation.

The curing of the curable composition may be carried out at a predetermined temperature and for a predetermined period of time sufficient to cure the composition. The curing may be dependent on the components used in the formulation such as the type of hardeners used in the formulation.

For example, the temperature of curing the formulation may be generally from 50° C. and 200° C. in one embodiment, from 75° C. to 175° C. in another embodiment, and from 100° C. to 150° C. in still another embodiment.

The curing time period of the curable composition is beneficially within 24 hours in one embodiment, from 0.1 hour to 24 hours in another embodiment, and from 0.2 hour to 12 hours in still another embodiment.

For example, the temperature of curing the curable formulation may be generally from 50° C. to 200° C. in one embodiment; from 75° C. to 175° C. in another embodiment; and from 100° C. to 150° C. in still another embodiment.

The period of time for curing the curable formulation may be generally from 1 minute to 24 hours in one embodiment, from 5 minutes to 12 hours in another embodiment, and from 10 minutes to 6 hours in still another embodiment. Below a period of time of 1 minute, the time may be too short to ensure sufficient reaction under conventional processing conditions; and above 24 hours, the time may be too long to be practical or economical.

The divinylarene dioxide of the present invention such as divinylbenzene dioxide (DVBDO), which is the epoxy resin component of the curable composition of the present invention, may be used as the sole resin to form the epoxy matrix in the final formulation; or the divinylarene dioxide resin may be used in combination with another epoxy resin that is different from the divinylarene dioxide as the epoxy component in the final formulation. For example the different epoxy resin may be used as an additive diluent.

In one embodiment, the use of divinylbenzene dioxide such as DVBDO imparts improved properties to the curable composition and the final cured product over conventional glycidyl ether, glycidyl ester or glycidyl amine epoxy resins. The DVBDO's unique combination of low viscosity in the uncured state, and high Tg after cure due to the rigid DVBDO molecular structure and increase in cross-linking density enables a formulator to apply new formulation strategies. In addition, the ability to cure the epoxy resin with an expanded hardener range, offers the formulator significantly improved formulation latitude over other types of epoxy resins such as epoxy resins of the cycloaliphatic type resins (e.g., ERL-4221, formerly from The Dow Chemical Company).

As is well known in the art, curable compositions are converted upon curing from a liquid, paste, or powder formulation into a durable solid cured composition. The resulting cured composition of the present invention displays such excellent properties, such as, for example, surface hardness. The properties of the cured compositions of the present invention may depend on the nature of the components of the curable formulation. In one preferred embodiment, the cured compositions of the present invention exhibit a Shore A hardness value of from 5 to 100, from 10 to 100 in another embodiment, and from 20 to 100 in yet another embodiment. In another preferred embodiment, the cured compositions of the present invention exhibit a Shore D hardness value of from 5 to 100, from 10 to 100 in another embodiment, and from 20 to 100 in yet another embodiment.

The curable composition of the present invention may be used to manufacture coatings, films, adhesives, binders, sealants, laminates, composites, electronics, and castings.

### EXAMPLES

The following catalysts were used in the Examples herein below: Cycat 600 (70 wt. % dodecylbenzenesulfonic acid in isopropanol commercially available from Cytec, Inc.), methyl p-toluenesulfonate (MPTS), methyl methanesulfonate (MMS), methyl trichloroacetate (MTCA), methyl trifluoroacetate (MFTA), and tetraethylmethylenediphosphonate (TEMDP).

In the following Examples, glass transition temperature (T_{g}) is measured either by differential scanning calorimetry (DSC) as the temperature at the half-height of the heat flow curve using a temperature scan rate of 10° C./minute or by thermomechanical analysis (TMA) as the temperature at the extrapolated onset point of the dimensional change curve using a temperature scan of 10° C./minute; and formulation viscosity is measured using a parallel plate rheometer operated at a shear rate of 10 s⁻¹ and a temperature of 25° C.

### Examples 1-3

Examples 1-3 illustrate the curing of DVBDO with latent catalytic curing agents MTCA, MTFA, and TEMDP, respectively. To a 20 mL vial were added 5 g of DVBDO and 0.05-0.06 g of latent catalytic curing agents (MTCA, MTFA, or TEMDP) as shown in Table I. The formulations were mixed at room temperature (nominally 25° C.), poured into a 5.08 cm aluminum dish, and placed into an air-recirculating oven to cure for 30 minutes each at 60° C., 70° C., 80° C., 90° C., 100° C., 105° C., 110° C., 115° C., 120° C., 120° C., and 150° C. The samples were then post-cured from ambient to 250° C. at 10° C./minutes. The resulting thermosets were analyzed by DSC analysis and the results of the analysis are described in Table I.

TABLE I

| | Catalytic Curing Agent | | DSC T_{g} |
|---|---|---|---|
| Example No. | type | (wt %) | (° C.) |
| Example 1 | MTCA | 5 | 103 |
| Example 2 | MTFA | 5 | 94 |
| Example 3 | TEMDP | 5 | 95 |

The above Examples show that latent catalytic curing agents MTCA, MTFA, and TEMDP cure DVBDO at elevated temperatures.

### Examples 4 and 5 and Comparative Example A

Examples 4 and 5 and Comparative Example A illustrate the curing of DVBDO with latent catalytic curing agents MPTS, MMS, and Cycat 600, respectively. To a 8 oz. (237 mL) jar were added 25 g of DVBDO and 0.05-0.06 g of latent catalytic curing agents (MPTS, MMS, or Cycat 600). The formulations were mixed at room temperature, poured into a 6″×6″×0.125″ (15.2×15.2×0.32 cm) aluminum mold, and placed into an air-recirculating oven to cure for 30 minutes each at 60° C., 70° C., 80° C., 90° C., 100° C., 105° C., 110° C., 115° C., 120° C., 120° C., and 150° C. The samples were then post-cured for 30 minutes each at 160° C., 170° C., 185° C., 200° C., and 225° C. The resulting thermosets were analyzed by TMA analysis and the results of the analysis are described in Table II.

TABLE II

| | Catalytic Curing Agent | | TMA T_{g} |
|---|---|---|---|
| Example No. | type | wt. % | (° C.) |
| Example 4 | MPTS | 0.2 | 373 |
| Example 5 | MMS | 0.2 | 373 |
| Comparative Example A | Cycat 600 | 0.2 | 377 |

The above Examples show that latent catalytic curing agents MPTS and MMS cure DVBDO at elevated temperatures. MPTS and MMS are more effective latent catalytic curing agents than are MTCA, MTFA, and TEMDP; and the latent catalytic curing agents of the present invention are equally as effective as the non-latent catalyst Cycat 600.

### Examples 6-10 and Comparative Examples B-E

Examples 6-10 and Comparative Examples B-E illustrate the formulation stability of DVBDO with MPTS, MMS, and Cycat 600. To a 20 mL vial were added 10 g of DVBDO and 0.1 g of latent catalytic curing agents (MPTS, MMS, or Cycat 600). The formulations were mixed and allowed to stand at room temperature. The viscosity of the curable formulations was measured over a period of 7 days and the results are described in Table III.

TABLE III

| | Catalytic | | | | |
|---|---|---|---|---|---|
| | Curing Agent | Viscosity (mPa-s) | | | |
| Example No. | type | wt. % | initial | +7 days | VIF |
| Example 6 | MPTS | 1 | 11 | 12 | 1.1 |
| Example 7 | MMS | 1 | 11 | 12 | 1.1 |
| Example 8 | MTCA | 1 | 10 | 10 | 1.0 |
| Example 9 | MTFA | 1 | 11 | 12 | 1.1 |
| Example 10 | TEMDP | 1 | 11 | 13 | 1.2 |
| Comparative Example B | Cycat 300 | 1 | 13 | 117 | 9.0 |
| Comparative Example C | BDMA | 1 | 11 | 18 | 1.6 |
| Comparative Example D | BDMA | 2 | 11 | 48 | 4.4 |

The above Examples show that the latent catalytic curing agents MPTS, MMS, MTCA, MTFA, and TEMDP provide a viscosity increase factor (VIF), which is the ratio of viscosity after 7 days to initial viscosity, of less than or equal to 1.2 vs. 9.0 or 4.4 for the non-latent catalysts Cycat 600 and BDMA. According to U.S. Pat. No. 2,924,580, BDMA at 1 wt % (Comparative Example C) does not cure DVBDO but nonetheless has a significantly greater viscosity increase factor (1.6) than the latent catalytic curing agents of the present invention.

1. A curable composition comprising (a) at least one divinylarene dioxide and (b) at least one latent catalytic curing agent.

2. The composition of claim 1, wherein the viscosity increase factor of the composition is less than 4.

3. The composition of claim 1, wherein the viscosity increase factor of the composition is from 1.0 to 4.

4. The composition of claim 1, wherein the at least one latent catalytic curing agent comprises at least one alkylating ester.

5. The composition of claim 4, wherein the at least one alkylating ester catalytic curing agent comprises an ester of a sulfonic acid, an ester of a phosphonic acid, an ester of an α-halogenated carboxylic acid, or mixtures thereof.

6. The composition of claim 5, wherein the at least one alkylating ester catalytic curing agent comprises methyl p-toluenesulfonate, methyl methanesulfonate, methyl trichloroacetate, methyl trifluoroacetate, tetraethylmethylenediphosphonate or mixtures thereof.

7. The composition of claim 1, wherein the concentration of the at least one latent catalytic curing agent comprises from 0.01 weight percent to 20 weight percent.

8. The composition of claim 1, wherein the at least one divinylarene dioxide comprises divinylbenzene dioxide.

9. The composition of claim 1, including an additional epoxy resin different from the divinylarene dioxide, a co-reactive curing agent, an additional catalytic curing agent different from the latent catalytic curing agent, a filler, a reactive diluent, a flexibilizing agent, a processing aide, a toughening agent, or a mixture thereof.

10. A process for preparing a curable composition comprising admixing (a) at least one divinylarene dioxide and (b) at least one latent catalytic curing agent.

11. A process for preparing a cured composition comprising curing the composition of claim 1.

12. A cured article prepared by the process of claim 11.
